(19) United States
(12) Patent Application Publication
(10) Pub. No.: US 2009/0025575 A1
(43) Pub. Date: Jan. 29, 2009

(54) Garlic Press With Variable Grate Configurations

(75) Inventor: William J. Lazaroff, Floral Park, NY (US)

Correspondence Address: TROUTMAN SANDERS LLP, 600 PEACHTREE STREET , NE, ATLANTA, GA, 30308, US

(73) Assignee: Lifetime Brands, Inc., Garden City, NY (US)

(21) Appl. No.: 12/177,604

(22) Filed: Jul. 22, 2008

Related U.S. Application Data
(60) Provisional application No. 60/951,541, filed on Jul. 24, 2007.

(51) Int. Cl. A47J 19/00

(52) U.S. Cl. 99/510

(57) ABSTRACT

An adjustable garlic press that allows the user to choose among a variety of different grate assemblies with, for example, variable sized apertures/pattern of apertures. The apertures can be holes, or other forms, for example, in the form of dicers or slicers.

### CROSS REFERENCE TO RELATED APPLICATIONS

This application claims the benefit of U.S. Provisional Application No. 60/951,541, filed 24 Jul. 2007, which is hereby incorporated by reference in its entirety as if fully set forth below.

1. Technical Field of the Invention

The present invention relates generally to a food press and, more particularly, to a garlic press that is easy to operate, and has easy-to-use adjustment features.

2. Description of Related Art

Hand presses for garlic cloves, onions, and other food items, principally fruits and vegetables, come in a variety of configurations and modes of operation. Possibly the most common form of garlic press utilizes pivotally mounted hand-manipulatable arms with a perforated basket or receptacle on one arm and a pressure member or plunger on the other arm engageable within the basket for the crushing of garlic and the like.

Such known garlic presses have but a single grate configuration, or basket perforation configuration, usually being a set of uniformly spaced-apart, unitary-sized holes. Thus, with the conventional press, only one size of crush can be provided.

It would be beneficial to have a garlic press that was easy to operate, of relatively simple construction, yet provide the user with a selection of grate configurations, so the user can easily choose among a plurality of grate configurations to provide variable control over amounts of juice, and size/shape of crush, when pressing the food item. It is to such a device that the present invention is primarily directed.

### BRIEF SUMMARY OF THE INVENTION

Briefly described, in preferred form, the present invention is an adjustable garlic press that allows the user to utilize a variable grate assembly with, for example, variable sized apertures/patterns of apertures. The apertures can be holes, or other forms, for example, in the form of dicers or slicers. In this way, the present garlic press provides variable control over amounts of juice, and size/shape of crush. The variable grate assembly provides at least two variable sized apertures/patterns of apertures.

The grate assembly is variable preferably by means of a sliding insert. The sliding insert has at least two, and more preferably a plurality, of grate configurations, each grate configuration having, for example, differently sized apertures and/or a different aperture pattern from one grate configuration to the next.

Thus, the user can generate variable amounts of juice from a squeezed garlic clove via selection of the appropriate grate configuration, by sliding the sliding insert to the appropriate place so the desired grate configuration is under the plunger. As described, one or more of the grate configurations can be, for example, a slicer, instead of a perforated section for squeezing.

The sliding insert is located into the proper location of the head of the tool by means of a stopper/locator notch, fixed into the body of the tool.

These and other objects, features and advantages of the present invention will become more apparent upon reading the following specification in conjunction with the accompanying drawings.

### BRIEF DESCRIPTION OF THE FIGURES

FIGS. 1A-1B, collectively known as FIG. 1, are perspective views of the present invention, according to a preferred embodiment, wherein the press is in an open state (FIG. 1A), and a closed state (FIG. 1B).

FIG. 2 illustrates the present press according to a preferred embodiment, wherein the innovative insert of the grate assembly is shown in four (4) orientations of extension (from left to right), providing the press with four (4) different types of grate configurations.

FIG. 3 is a top view of the insert of the grate assembly of the present invention according to a preferred embodiment, providing the press with four (4) different types of grate configurations.

FIG. 4 is a top view of the present invention, according to another preferred embodiment.

FIG. 5 is a side view of FIG. 4.

FIG. 6 is a front view of FIG. 4.

FIGS. 7-9 are cross-sectional side views of FIG. 4, with varying extensions of the insert of the grate assembly.

FIG. 10 is a top view of the lower arm of the invention of FIG. 4.

FIG. 11 illustrates the pressing plunger assembly according to a preferred embodiment of the present invention.

FIG. 12 is a top view of the insert of FIG. 10.

FIG. 13 is a side view of the insert of FIG. 12.

FIG. 14 is a side view of the lower arm of the invention of FIG. 4.

FIG. 15 is a front view of the lower arm of the invention of FIG. 4.

### DETAILED DESCRIPTION OF THE PREFERRED EMBODIMENTS

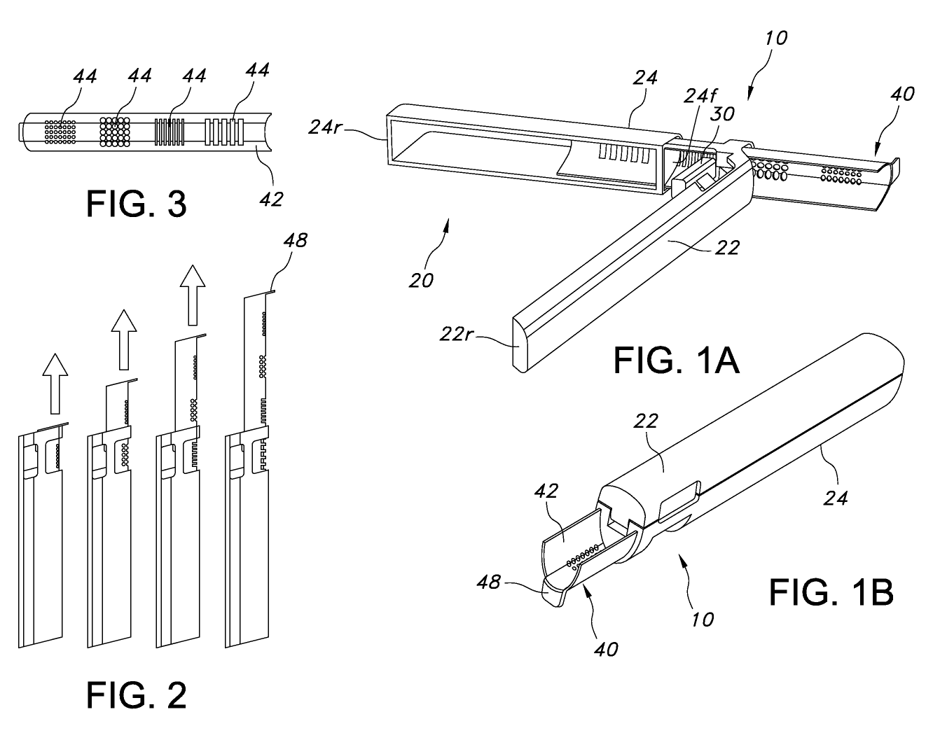

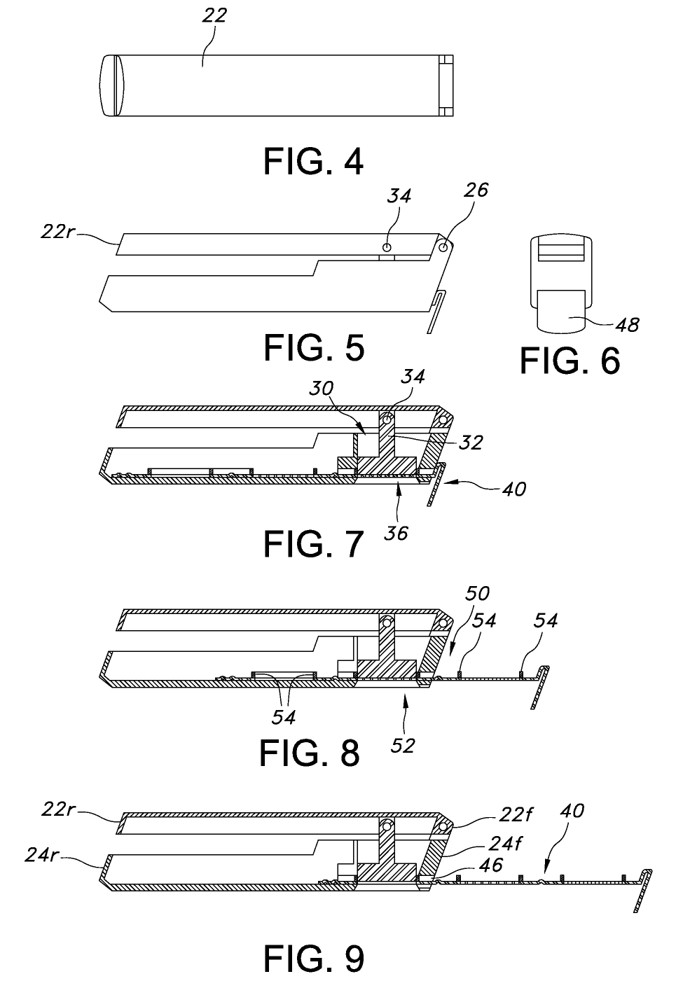

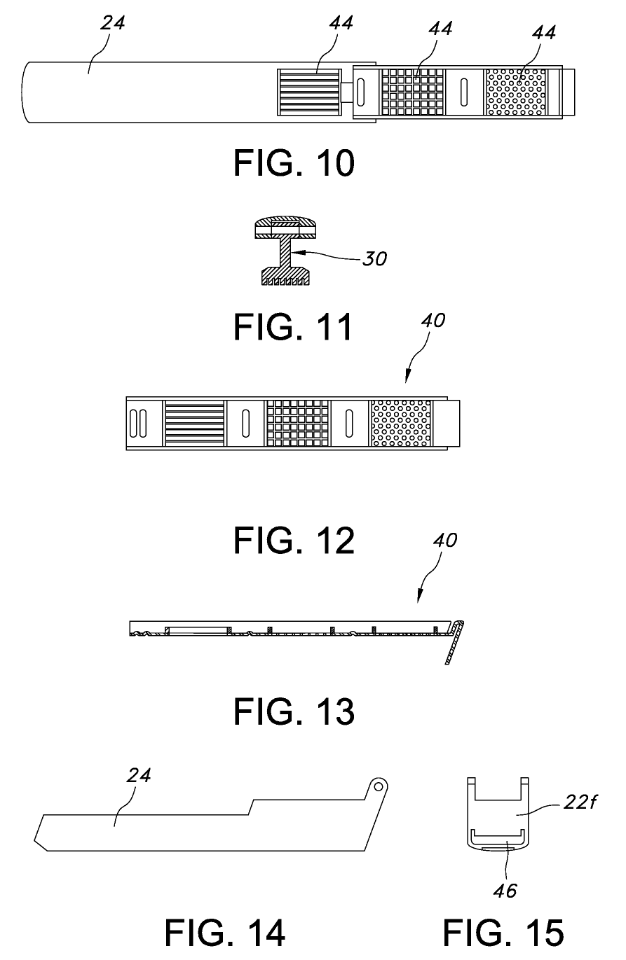

Referring now in detail to the drawing figures, wherein like reference numerals represent like parts throughout the several views, the present invention is a food press with variable grate configurations, each grate configuration having a different grate configuration, as shown in FIGS. 1-15.

The present food press provides the user with the ability to compress a food article, and upon selection of a grate configuration, extrude variable amounts of juice and/or variable sized/shaped segments of the food article. In a preferred embodiment, the present invention is a garlic press for compressing a clove of garlic, and upon user selection, extruding variable amounts of juice or slices of garlic.

The traditional garlic press comprises only one grate configuration through which the user squeezes a clove of garlic to produce juice. The present invention provides the option of multiple grate configurations, which can be conveniently located under the plunger upon sliding a cartridge with multiple grate configurations. The desired grate configuration of the cartridge slides in a body cavity of the lower arm of the press, and then is securedly located in place by means of a stopper/locator notch.

The present invention can be made of various materials, including plastics and metal. In a preferred embodiment, the press is formed of a material, or combination of materials, that are both dishwasher safe, and that can resist the force and pressure of squeezing a food item. The present invention should further be sized within the generally-accepted range of hand tools and kitchen gadgets.

The present garlic press 10 is shown in an open state (FIG. 1A), and a closed state (FIG. 1B), and comprises a body 20 having an upper portion 22 pivotally connected to a lower portion 24, a pressing plunger assembly 30, and a grate assembly 40. The present garlic press 10 can be utilized to provide a variety of crush, squeeze, peel, and/or grate operations for various food items, such as garlic, onions, and the like.

Upper and lower portions 22, 24 may also be referred to as hand-manipulatable upper and lower arms 22, 24. Each arm has a forward end and a rear end, and the arms 22, 24 are pivotally connected at their respective forward ends at pivot point 26. The arms 22, 24 can be formed of molded metal (preferred) or molded plastic. In one embodiment, the arms are formed cast zinc alloy. As an alternative to cast zinc alloy, other materials typically used in the manufacture of cutlery, such as, stainless steel, aluminum, aluminum alloys, steel alloys, or other metals or alloys, may be used.

The upper arm 22 is preferably of uniform U-shaped cross section along a majority of its length, having a closed rear end 22r, and pivotally attached at its front end to the lower arm 24 via the pivot point 26, preferably comprising a pin/rod extending through the front end of the upper arm 22, the pin/rod being mountable in cooperating apertures on either side of the inner surface of the front end of the lower arm 24.

The lower arm 24 also is preferably of uniform U-shaped cross section along a majority of its length, having a closed rear end 24r, and pivotally attached at its front end to the upper arm 22 via the pivot point 26. The front end 24f of the lower arm is provided with an insert recess 46, which is cooperative shaped with the slidable insert 42 of the grate assembly 40, so as to facilitate the slidable control of the insert 42 into, and out of, the lower arm 24 of the present press 10.

Along the length of the body 20, in closer proximity to the forward end than the rear end is the pressing plunger assembly 30, comprising a pivotally mounted plunger 32 mounted on the upper arm 22 at pivot point 34, and a pressing chamber 36 of the lower arm 24. The pressing plunger 32 preferably has a base surface (contacting the compressed food item) corresponding to the cross-sectional surface of the chamber 36.

The garlic press 10 further comprises the grate assembly 40, which in essence, provides the “bottom” or “floor” of the pressing chamber 36. The present invention enables a user to select the type of crush and juice flow by choosing from a variety of pressing chamber 36 “floors”, being grate configurations 44 of the grate assembly. When a food item is positioned in the pressing chamber 36, and the arms 22, 24 brought together, the plunger 32 begins squeezing the food item between the base surface of the plunger 32 and the floor of the chamber 36. Fluid is extruded from the food item, which exits through the apertures of the grate configurations 44 of the grate assembly 40, and since the configuration of the floor of the chamber 36 is variable, the user has control of the device not previously provided for in the art.

In a preferred embodiment, the grate assembly 40 is a slidable insert 42, slideable along the length of the lower arm 24, the insert 42 provided with at least two, and more preferably a plurality, of grate configurations 44. The slideable insert 42 is capable of sliding into the lower arm 24 via the insert recess 46 of the front end 24f of the lower arm. The front end of the insert 42 is provided with a pull 48, enabling relatively easy slideability to the insert 42 into and out of the lower arm 24.

The grate configurations 44 provide a plurality of different opening configurations, including a variance in the types of openings, number of openings, etc. The insert 42 of the Figs. illustrates but one example, that being an insert 42 having four (4) grate configurations 44.

The present press 10 is provided with one of a variety of grate configurations by changing the orientation of the insert 42 relative the arm 24. A particular choice of grate configuration is releasably secured by a securing assembly 50, which in a preferred embodiment can be a combination stopper/locator notch assembly 52 formed of a stopper 54 on the insert 42, and a notch 56 in the arm 24, which cooperatively work together to releasably secure a chosen grate configurations 44 in place.

The grate configuration 44 in one embodiment can include uniformly-shaped apertures through the entirety of the insert 42. In another embodiment, the apertures can be frusto-conical in shape with a taper from a smaller diameter at the top surface to a larger diameter at the bottom surface of the insert. This minimizes clogging of the holes and facilitates machining of the plate during manufacture. In other embodiments, the apertures can be holes, oval shaped, square, round triangular, rectangular, odd shaped, and combinations thereof.

Although certain embodiments of a garlic press have been described herein in accordance with the teachings of the present disclosure, the scope of coverage of this patent is not limited thereto. On the contrary, this patent covers all embodiments of the teachings of the disclosure that fairly fall within the scope of permissible equivalents.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. An adjustable food press comprising:
hand-manipulatable upper and lower arms having an open state, and a closed state;
a pressing plunger assembly; and
a variable grate assembly;
wherein in the open state, a food item can be placed into the pressing plunger assembly, and wherein upon moving the hand-manipulatable upper and lower arms into the closed state, at least a portion of the food item is pressed through the variable grate assembly, which variable grate assembly provides variable control over amounts of juice, and/or size/shape of crush, when pressing the food item in the adjustable food press.

2. The adjustable food press of claim 1, the pressing plunger assembly comprising a pivotally mounted plunger mounted to the upper arm, and a pressing chamber of the lower arm.

3. The adjustable food press of claim 1, the variable grate assembly comprising a slidable insert, slideable along a length of the lower arm, the insert having at least two different grate configurations.

4. The adjustable food press of claim 3, wherein the lower arm has an insert recess at a front end thereof, the insert recess cooperative shaped with the slidable insert of the grate assembly so as to facilitate the slidable control of the slidable insert into, and out of, the lower arm.

5. An adjustable food press comprising:
a body having an upper portion pivotally connected to a lower portion;
a pressing plunger assembly;
a variable grate assembly providing a plurality of different grate configurations; and
a securing assembly that releasably secures a selected grate configuration of the variable grate assembly;
wherein in an open state of the body, a food item can be placed into the pressing plunger assembly, and wherein upon moving the body into a closed state, at least a portion of the food item is pressed through a chosen grate configuration of the variable grate assembly, which variable grate assembly provides variable control of the different grate configurations, which provides variable control over amounts of juice, and/or size/shape of crush, when pressing the food item in the body.

6. The adjustable food press of claim 5, the pressing plunger assembly comprising a pivotally mounted plunger mounted to the upper portion, and a pressing chamber of the lower portion.

7. The adjustable food press of claim 5, the variable grate assembly comprising a slidable insert, slideable along a length of the lower portion, the insert having the plurality of different grate configurations.

8. The adjustable food press of claim 7, wherein the lower portion has an insert recess at a front end thereof, the insert recess cooperative shaped with the slidable insert of the grate assembly so as to facilitate the slidable control of the slidable insert into, and out of, the lower portion.

9. The adjustable food press of claim 8, wherein the securing assembly comprises the cooperative engagement of one or more stopper/locator notch assemblies on the slidable insert, with a notch in the lower portion, which cooperatively work together to releasably secure a chosen grate configurations in place.

10. The adjustable food press of claim 5, wherein the upper and lower portions are uniformly U-shaped in cross section along a majority of their length, the portions having closed rear ends, and the portions pivotally attached at respective front ends to one another.
